(19) United States
(12) Patent Application Publication
(10) Pub. No.: US 2009/0324818 A1
(43) Pub. Date: Dec. 31, 2009

(54) Silicone applicator for a printing press

(75) Inventor: David John Gagnon, Somersworth, NH (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/213,887

(22) Filed: Jun. 25, 2008

(51) Int. Cl. B05D 1/28; B05C 11/10

(52) U.S. Cl. 427/211; 118/708

(57) ABSTRACT

A silicone application system for a web printing press includes at least one silicone applicator having a first web width application zone and a second web width application zone controlled independently of the first web with application zone. A web printing press and method are also disclosed.

The present invention relates generally to printing presses and more particularly to an applicator formed to receive a liquid thereon and for at least to partly transfer the liquid onto a printed moving web or ribbon.

### BACKGROUND

In a rotary printing press, a material web is guided through a plurality of printing units where the web may be printed on both sides and in many colors. It is then guided into a dryer, for example, a hot air dryer, in order to dry it. The web is then transported over cooling rollers of a cooling stand in order to cool down the web heated by the dryer. Thereafter, the web may be cut and folded into signatures in a folder and the signatures transported onward for further processing in, for example, a distribution system.

Presently, it is known to apply silicone to a full web or a full ribbon. U.S. Pat. No. 6,936,105 discloses a roller applicator for applying a liquid solution to a web. The silicone is transferred by a rotating applicator that resides in a reservoir of silicone emulsion. Coating the printed web with a silicone emulsion in the form of a thin film prevents the ink on the printed web from being smeared when in the region of turner bars or in the folder.

U.S. Pat. No. 6,936,105 is hereby incorporated by reference herein.

### SUMMARY OF THE INVENTION

U.S. Pat. No. 6,936,105 limits the possibility for silicone to be applied to a specific area or areas of a full web. The silicone is limited to being applied to the full width of the web or not being applied at all. Thus, there can be excess or insufficient silicone in zones over the full web width.

Furthermore, if there is a current requirement for multiple ribbons to be coated with silicone in a given process, multiple applicator rolls and all the components, such as reservoirs, motors and bearings, must be provided for each web and ribbon, which is costly.

The present invention provides a silicone application system for a web printing press comprising: a silicone applicator having a first web width application zone and a second web width application zone controlled independently of the first web with application zone.

The silicone application system may include a controller controlling the silicone applicator to permit selective application of the silicon in the first web width application and second web width application zones.

The present invention also provides a web printing press comprising at least one print unit and the silicone application system of the present invention.

The present invention also provides a method for providing silicone to a web comprising:

determining a desired web width application zone; and

controlling an application width of a silicone applicator as a function of the determination.

### BRIEF DESCRIPTION OF THE DRAWINGS

Further features and advantages of the present invention will become apparent from the following detailed description taken in conjunction with the accompanying drawings, in which:

FIG. 1 shows a printing press according to the present invention;

FIG. 2 shows a top view of FIG. 1;

FIG. 3 shows another embodiment of the present invention;

FIG. 4 shows a top view of FIG. 3.

### DETAILED DESCRIPTION OF PREFERRED EMBODIMENTS

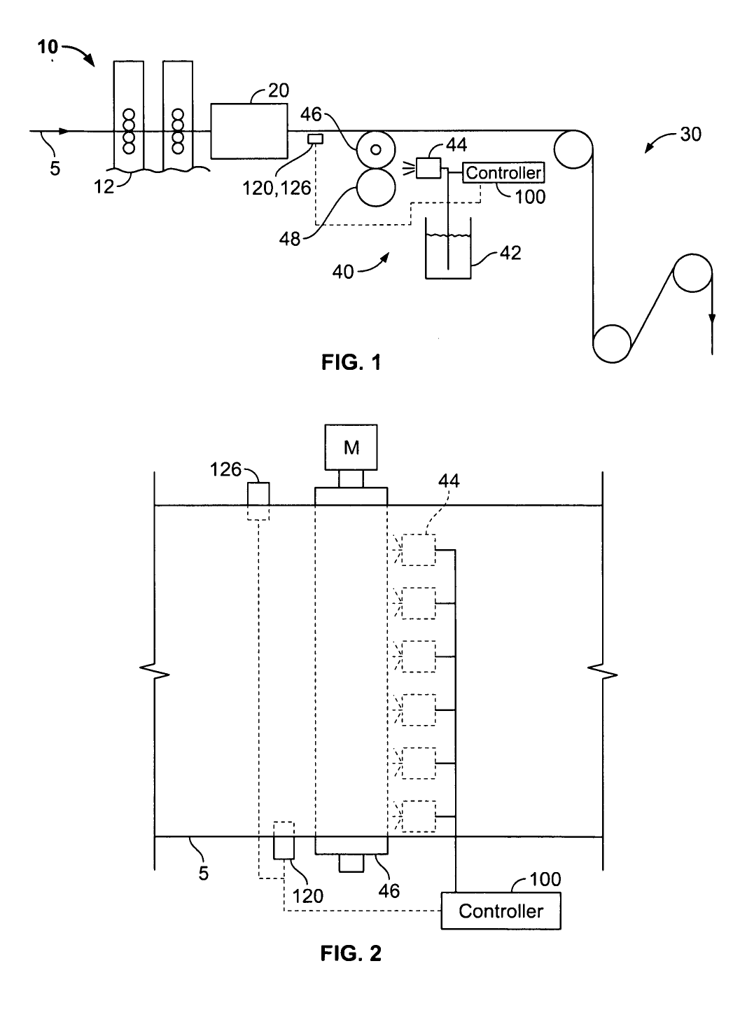

FIG. 1 shows a web rotary printing press 10 including at least one printing unit 10 printing a web 5. Web 5 is dried by a hot air dryer 20 and passes to a downstream cooling stand 30.

Since the ink may not fully set after exiting the dryer 20, a printing ink buildup on the guide rolls or guide surfaces in the cooling stand 30 and subsequent press components, such as in the folding machine, may occur nevertheless. This ink buildup may be countered by applying a silicone emulsion onto web 5 using a silicon application system 40.

Silicone application system 40 used to apply a silicone emulsion onto web 5 may be located before or after cooling stand 30. Due to the relatively small size of the silicone application system 40, system 40 also may be located within the cooling stand 30.

As shown in FIGS. 1 and 2, silicone application system 40 includes a motor driven chrome roll 46 driven by motor M and a rubber roll 48, which can press against chrome roll 46 using, for example, a hydraulic, pneumatic or another linear motion actuating device. Application system 40 also includes a series of spray nozzles 44 connected to a reservoir 42 containing a silicone solution. Spray nozzles 44 spray the solution onto the nip point between roll 46 and roll 48, so that roll 48 thereafter applies silicone onto the underside of the full web 5. Advantageously, silicone may also be similarly applied to the top of the full web 5 using a similar arrangement. Spray nozzles 44 may be controlled, for example, by solenoid valves which would allow for remote and pre-set operation using a controller 100. This then allows controller 100 to apply the silicone solution at a desired flow rate and to any desired area or zone of web 5, for example via automatic control or an operator.

Furthermore, having multiple spray nozzles 44 means that nozzles 44 may be adjusted to spray silicon on one or more ribbons of any width. The quantity of nozzles 44 actually providing the silicone may vary depending on the desired location of the spray, the web width, by ribbon quantity or by ribbon width. Web width sensors 120, 126 may be used to determine a web width or location so that controller 100 can control the silicone applicator nozzles 44 automatically as a function of the web width or location.

By having selective application, the amount and placement of silicone can be controlled, reducing the amount of silicone needed to be applied, and permitting selective zoning of silicone of desired. For example, of gumming or other issues downstream on specific axial areas is detected, additional silicone could be applied to that axial location to attempt to reduce the gumming.

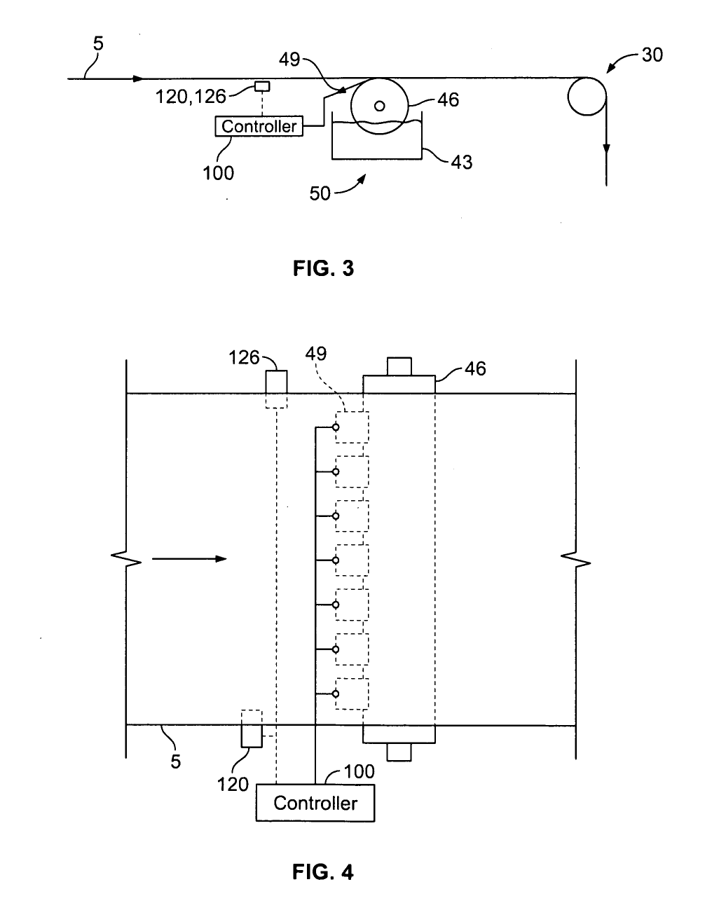

In another embodiment, FIGS. 3 and 4 illustrate a silicone application system 50 using blades 49 made of, for example, plastic, metal or rubber to scrape off or restrict the flow of a silicone emulsion coming from reservoir 43 onto chrome roll 46. Using multiple blades 49 (shown apart for clarity but capable of being spaced close together) allows application of the silicone solution to be controlled to any axial area or zone of web 5.

Blades 49 may be moved away and toward the roll 46 by, for example, individual rotary actuators, a mechanism or by hand. The number of blades 49 may be limited only by the desired location on the web, web width, number of ribbons or ribbon width. A web width sensor 120, 126 may be used to determine a web width so that controller 100 can control the silicone applicator blades 49 automatically as a function of the web width.

The foregoing merely illustrates the principles of the invention. It will thus be appreciated that those skilled in the art will be able to devise numerous other arrangements which embody the principles of the invention and are thus within its spirit and scope. For example, based on the above disclosure, it is apparent that the principles of the invention can readily accommodate different control schemes other than a solenoid valve for remote operation and still achieve the benefits of the invention. Another example is that blades 49 and nozzles 44 can be pre-set or operated by hand.

What is claimed is:

1. A silicone application system for a web printing press comprising:
at least one silicone applicator having a first web width application zone and a second web width application zone controlled independently of the first web with application zone.

2. The system as recited in claim 1 further comprising a controller controlling the silicone applicator to permit selective application of the silicon in the first web width application and second web width application zones.

3. The system as recited in claim 2 further comprising a web width or location sensor connected to the controller, the controller controlling the silicone applicator as a function of the sensor.

4. The system as recited in claim 1 wherein the silicone applicator includes a plurality of individual silicone applicators located axially apart from one another.

5. The system as recited in claim 4 wherein the silicone applicator includes a roll contacting the web, the applicator spraying silicone on the roll.

6. The system as recited in claim 5 wherein the roll is motor driven.

7. The system as recited in claim 1 wherein the silicon applicator applies silicone across an entire web width and further includes controllable blades located axially apart from one another.

8. A web printing press comprising at least one print unit and the silicone application system as recited in claim 1.

9. The web printing press as recited in claim 8 further comprising a dryer and a cooling stand downstream of the print unit.

10. The web printing press as recited in claim 9 wherein the silicone application system is upstream or within the cooling stand.

11. A method for providing silicone to a web comprising:
determining a desired web width application zone; and
controlling an application width of a silicone applicator as a function of the determination.
